(19) United States
(12) Patent Application Publication
(10) Pub. No.: US 2011/0203311 A1
(43) Pub. Date: Aug. 25, 2011

(54) REMOVAL OF CARBON DIOXIDE FROM AIR

(76) Inventors: Allen B. Wright, Tucson, AZ (US); Klaus S. Lackner, Dobbs Ferry, NY (US)

(21) Appl. No.: 13/060,172

(22) PCT Filed: Aug. 24, 2009
(86) PCT No.: PCT/US09/54795

§ 371 Date: May 6, 2011

Related U.S. Application Data
(60) Provisional application No. 61/091,327, filed on Aug. 22, 2008.

(51) Int. Cl. F25J 1/02; B01D 53/04; F25J 3/08

(52) U.S. Cl. 62/602; 95/139; 62/617

(57) ABSTRACT

The present disclosure provides a method and apparatus for removing a contaminant, such as carbon dioxide, from a gas stream, such as ambient air. The contaminant is removed from the gas stream by a sorbent, which is regenerated in a regeneration unit either by utilizing a thermal swing or a humidity swing or a combination thereof. Heat is conserved in the present disclosure by employing a heat exchanger to transfer heat from the regenerated sorbent to an amount of sorbent that is loaded with the contaminant prior to regeneration. The heat exchanger may employ water or another fluid as a refrigerant to draw heat from the regenerated sorbent and transferring that heat to the loaded sorbent.

The present disclosure relates to removal of selected gases from air. The disclosure has particular utility in connection with the extraction of carbon dioxide (CO₂) from the atmosphere and subsequent sequestration of the extracted CO₂ or conversion of the extracted CO₂ to useful or benign products and will be described in connection with such utilities, although other utilities are contemplated, including the extraction, sequestration or conversion of other gases from the atmosphere including NOₓ and SO₂.

There is compelling evidence to suggest that there is a strong correlation between the sharply increasing levels of atmospheric CO₂ with a commensurate increase in global surface temperatures. This effect is commonly known as Global Warming. Of the various sources of the CO₂ emissions, there are a vast number of small, widely distributed emitters that are impractical to mitigate at the source. Additionally, large scale emitters such as hydrocarbon-fueled power plants are not fully protected from exhausting CO₂ into the atmosphere. Combined, these major sources, as well as others, have lead to the creation of a sharply increasing rate of atmospheric CO₂ concentration. Until all emitters are corrected at their source, other technologies are required to capture the increasing, albeit relatively low, background levels of atmospheric CO₂. Efforts are underway to augment existing emissions reducing technologies as well as the development of new and novel techniques for the direct capture of ambient CO₂. These efforts require methodologies to manage the resulting concentrated waste streams of CO₂ in such a manner as to prevent its reintroduction to the atmosphere.

The production of CO₂ occurs in a variety of industrial applications such as the generation of electricity power plants from coal and in the use of hydrocarbons that are typically the main components of fuels that are combusted in combustion devices, such as engines. Exhaust gas discharged from such combustion devices contains CO₂ gas, which at present is simply released to the atmosphere. However, as greenhouse gas concerns mount, CO₂ emissions from all sources will have to be curtailed. For mobile sources the best option is likely to be the collection of CO₂ directly from the air rather than from the mobile combustion device in a car or an airplane. The advantage of removing CO₂ from air is that it eliminates the need for storing CO₂ on the mobile device.

Extracting carbon dioxide (CO₂) from ambient air would make it possible to use carbon-based fuels and deal with the associated greenhouse gas emissions after the fact. Since CO₂ is neither poisonous nor harmful in parts per million quantities, but creates environmental problems simply by accumulating in the atmosphere, it is possible to remove CO₂ from air in order to compensate for equally sized emissions elsewhere and at different times.

The art has proposed various schemes for removal of CO₂ from combustion exhaust gases or directly from the air by subjecting the gases or air to a pressure swing or a thermal swing using a CO₂ adsorbent. These processes use pressure or temperature changes, respectively, to change the state of the sorbent material, whereby to release the CO₂. Different sorbent materials are disclosed, including zeolites, amines, and activated alumina. See, for example, U.S. Pat. No. 4,711,645; U.S. Pat. No. 5,318,758; U.S. Pat. No. 5,914,455; U.S. Pat. No. 5,980,611; U.S. Pat. No. 6,117,404; and co-pending U.S. application Ser. No. 11/683,824.

None of these references, however, provides an particularly efficient process for the removal of CO₂, primarily due to the amount of energy expended in CO₂ recovery and sorbent regeneration.

The present disclosure provides improvements over the prior art as described above. More particularly, the present disclosure provides a method and apparatus for removing a contaminant from a gas stream by utilizing one of a number of methods, whereby heat is conserved throughout the process.

In one aspect the present disclosure provides a method and apparatus for extracting a contaminant (such as carbon dioxide) from a gas stream using a sorbent employing a thermal swing. The gas stream is brought in contact with a sorbent which captures the contaminant from the gas stream, wherein the sorbent becomes at least partially saturated with contaminant. The contaminant carrying sorbent is then placed in a regeneration unit to release the contaminant from the sorbent and regenerate the sorbent. The regeneration unit is maintained at a temperature that is higher than the temperature of the gas stream. The regenerated sorbent may then be removed from the regeneration unit. The heat given off by the regenerated sorbent is recovered before the regenerated sorbent is returned to the capture unit.

Another aspect of the present disclosure provides an improved method and apparatus which employs nitrogen as an energy storage to aid in the concentration and storage of carbon dioxide (CO₂) that has been extracted from air by using a sorbent that is sensitive to a humidity swing. Liquid nitrogen or liquid air is used to cool the gas mixture, thereby condensing water vapor out of the gas mixture.

Yet another aspect of the present disclosure provides a method for removing and sequestering a contaminant contained a gas stream. The contaminant is first removed from the gas stream by using a sorbent sensitive to a humidity swing. The sorbent material is then wetted to release the contaminant to an off-stream, the off-stream containing primarily water vapor and the contaminant. The water vapor may then be removed from the off-stream by passing the off-stream through an evaporative cooling chamber, wherein the evaporative cooling chamber is cooled by a low-temperature brine.

Further features and advantages of the present invention will be seen from the following detailed description, taken in conjunction with the accompanying drawings, wherein:

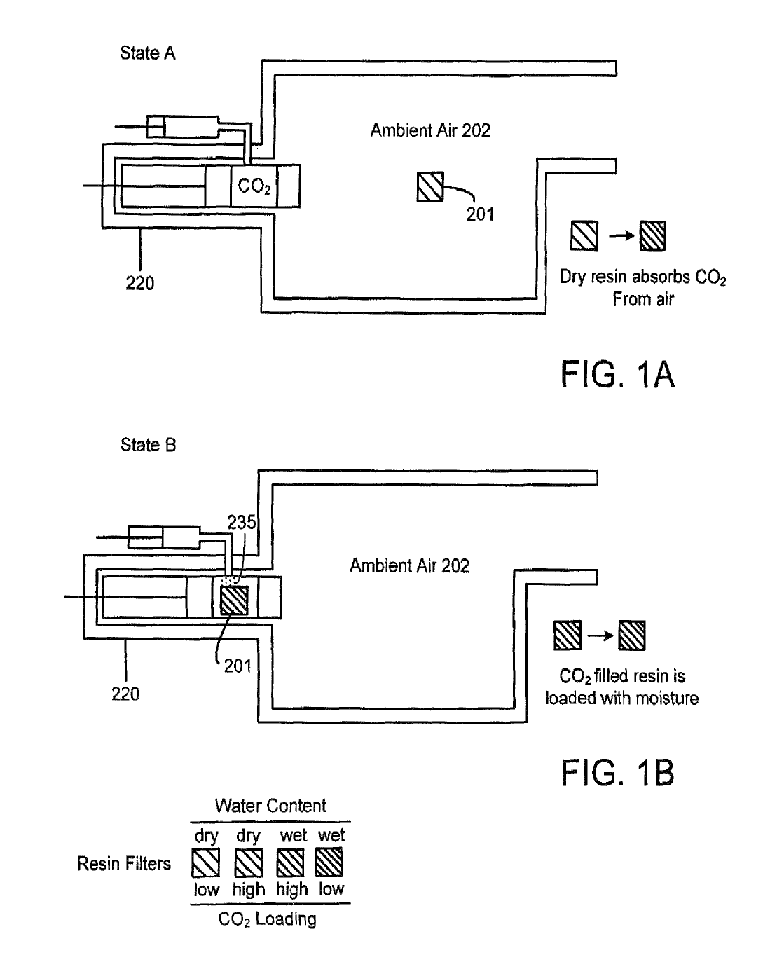

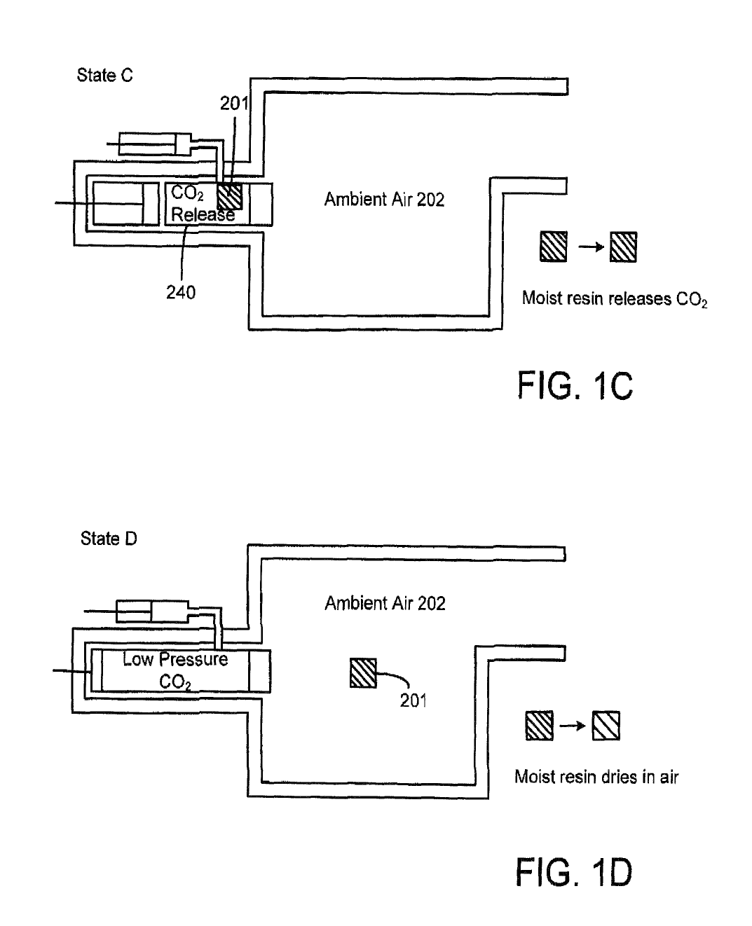

FIGS. 1A-1D are illustrations of a process for capturing a contaminant from a gas stream using a water-sensitive sorbent according to the present disclosure;

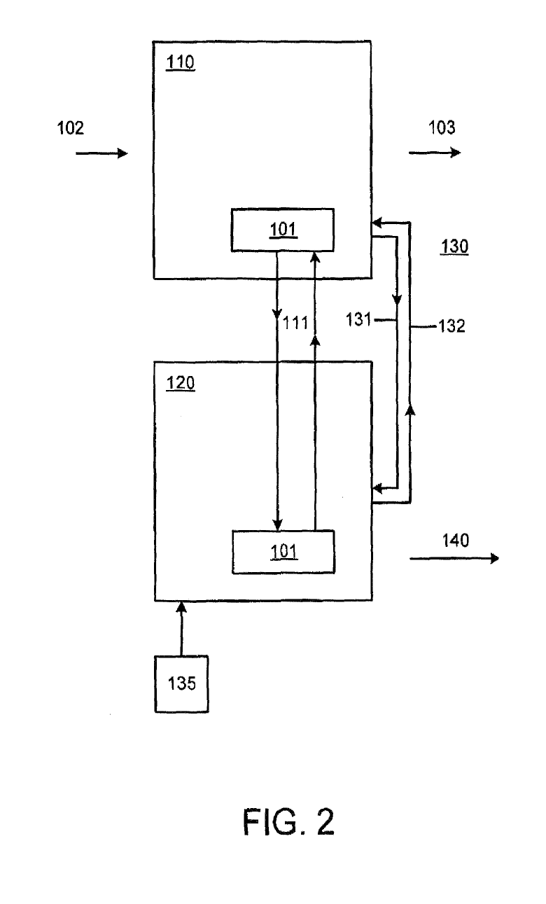

FIG. 2 is a schematic of a process for capturing a contaminant from a gas stream by utilizing a thermal swing; and

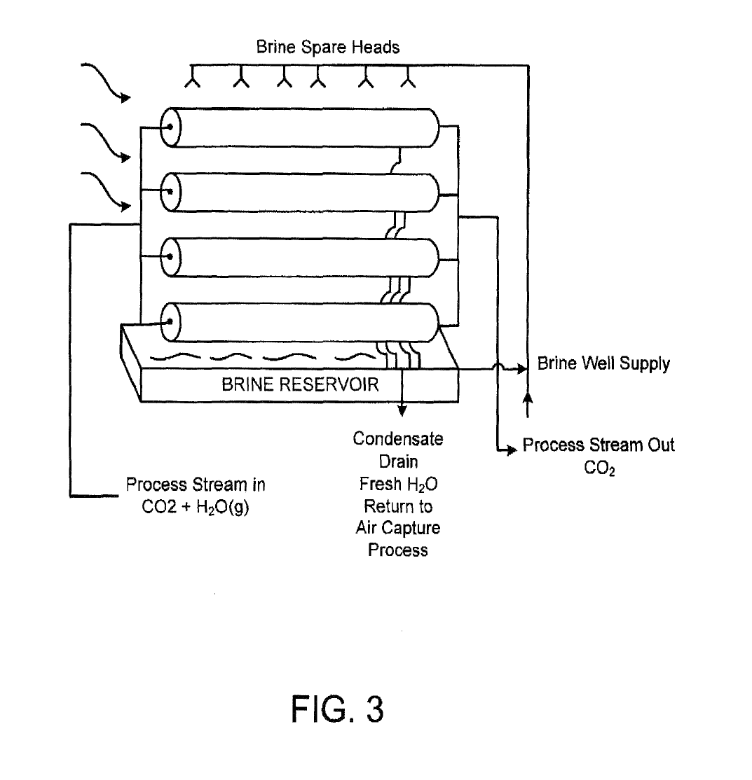

FIG. 3 is an illustration of an apparatus for capturing CO2 from a gas stream using available fluids to maintain the temperature of the system.

The present disclosure provides a method and apparatus for the extraction of a contaminant from a gas stream. The present disclosure is discussed in reference to a method and apparatus for capturing CO₂ from ambient air, but the technology is also applicable to exhaust air or other gas streams and may be used to capture hydrogen sulfide, ammonia, or other common contaminants from such gas streams.

In co-pending Patent Appln. Serial No. PCT/US07/84880 and Provisional Patent Appln. Ser. No. 60/985,586, assigned to a common assignee and incorporated by reference herein, we discuss a CO₂ capture process that utilizes a humidity swing to regenerate a sorbent, releasing a mixture of CO₂ and water vapor. The water vapor may be removed from the mixture by compression or cooling, either of which will cause the water vapor to condense and precipitate out of the mixture.

To perform the humidity swing, it is useful to expose the sorbent to low pressure water vapor. In order to achieve the required minimum water vapor pressure, it is may be necessary to operate above ambient temperatures as the maximum water vapor pressure depends strongly on the temperature. To that end, the aforementioned co-pending applications discuss how to transfer heat to loaded sorbents that need to be inserted into an environment that is at a higher temperature.

Where compression is used to condense the water out of the resulting gas mixture, the heat produced by that process can be transferred to the sorbent to raise its temperature as required. Alternatively, the heat required to drive the sorbent to the requisite temperature also can be derived from the condensation of water that has been allowed to evaporate at ambient conditions.

In another aspect of the present disclosure, we provide an improvement for a CO₂ capture process using a sorbent that employs a humidity swing. Specifically, the previously mentioned co-pending applications discuss a sorbent that passively absorbs CO₂ from the air. The CO₂ is recovered by using moisture to draw CO₂ from the sorbent. The cycle is completed by drying out the sorbent in a regeneration step. The steps of the process can be represented as a series of states through which the apparatus must pass.

Referring to FIGS. 1A-D, the sorbent 201 begins in a dry state and absorbs CO₂ from a volume of ambient air 202 passing over the sorbent until the sorbent has reached saturation or the absorption rate has slowed down to become inefficient. (See FIG. 1A). The sorbent is then enclosed in a separate chamber 220 from which air may be removed. After the air has been removed, moisture 235 is added, which results in a physical change in the properties of the resin. (See FIG. 1B). After taking on a sufficient amount of moisture, the resin unloads CO₂ and creates a partial pressure of CO₂ up to two hundred times larger than the ambient partial pressure of CO₂ in the air. The off-gas 240, consisting of CO₂ mixed together with some water vapor is pumped out of the chamber and enters a compression train where it is brought to the desired state. (See FIG. 1C). The resin is again exposed to ambient air, which causes it to dry. After drying the resin has reverted back into its original state and the cycle has been closed. (See FIG. 1D)

The sorbent is an anionic exchange resin that has been prepared in a state of sufficient basicity to absorb CO₂ from the air. The resin should contain between 1 to 2 moles of positive charges per kilogram of resin that are tightly bound into the polymer structure. In the specific resin used by the applicant, quartenary amines attach to a polystyrene backbone with a density of about 1.7 mol/kg. The mobile negative ions in these commercially available resins are typically chloride ions. In order to prepare the resin as a CO₂ absorber, it is necessary to replace the chloride ions with hydroxide, carbonate or bicarbonate ions. Conceptually, it is easiest to start with the well defined initial state, provided by a hydroxide wash. The hydroxide wash will effectively replace all chloride ions with hydroxide ions. In practice, as discussed below it is sufficient to wash the resin in a carbonate solution.

A resin, thus prepared, will readily absorb CO₂ from ambient air or another gas stream. The chemical reactions involve the mobile ions and are those of any carbonate system:

OH—+CO₂→HCO₃—

2OH—+CO₂→CO₃——+H₂O

CO₃——+H₂O+CO₂→2HCO₃—

For a dry resin, the water produced and consumed in the second and third equation is most likely held by the polymer matrix, which is highly hygroscopic and hence always ready to provide or accept the necessary water.

The resin may be referred to as being in a “hydroxide” state where there is no CO₂ attached to the cations, and as being in a “carbonate” state where there is one CO₂ for every two monovalent cations, and in a “bicarbonate” state where there is one CO₂ per monovalent ion. The system may further be described using a loading variable x, which refers to the ratio of CO₂ molecules per monovalent positive ion. This variable ranges from 0≦x≦1, as the resin loads with CO₂. The maximum carbon loading of the resin is given by the total number of positive ionic charges present on the resin, which is between 1 and 2 mole per kg. Thus, effectively the resin acts as a 1 to 2 molar solution of sodium hydroxide (NaOH). However, the uptake rates are faster than those of a sodium hydroxide solution, and the equilibrium loading with CO₂ under ambient conditions is far higher than that of a NaOH solution.

For a resin washed in NaOH, the observed uptake rates are much higher than those of a one molar NaOH solution. For a resin washed in sodium carbonate, the uptake rate is still comparable and even slightly faster than that of a one molar sodium hydroxide solution. There are likely two distinct reasons for the high CO₂ uptake rate of solid sorbents. The first is that the rate limiting step for CO₂ uptake into an aqueous solution is the transition of CO₂ molecules from the gas phase into the liquid phase. This rate is a function of the solution's pH and is, in general, very slow, suggesting that it takes many collisions of a CO₂ molecule with the liquid surface before it successfully enters the liquid. This reflects a property of the CO₂ molecule and stands in marked contrast with uptake rates for SO₂, which are known to be very fast. In the case of the polymer surface, the uptake mechanism is different and may directly involve the ionic site which is far more exposed to the air than would be expected in a liquid solution. A second reason for the enhancement of the uptake rate is due to the fact that a water surface is always flat, whereas a solid surface can microscopically be much larger than the nominal surface area measured as the area of the geometric shape which defines the macroscopic outline of the resin. This area multiplier increases the number of collisions a CO₂ molecule will have with the surface and thus increase the chance of its eventual uptake. This area multiplier can be made very large by design, and it is available for most solid sorbent materials. It is this geometric advantage which ultimately favors solid sorbents over liquid sorbents.

The water content of the resin determines to a large extent its ability to absorb CO₂. We distinguish between a wet resin, with water adhering to its surface and dry resin which has been allowed to dry out in air, and which feels dry to the touch, but still has some water content. There is a range of states from extremely dry, to moderately dry to wet resins, which have been equilibrated with a range of humidity in air.

We have found that, under dry conditions, the resin is capable of approaching the bicarbonate state even if the partial pressure of CO₂ is only that of ambient air. This stands in contrast to the absorption capacity of a one molar sodium hydroxide solution that is in equilibrium with air at a loading factor only slightly higher than 0.5. For a dry, fully loaded resin that has been exposed to dry air, the loading factor is well above 0.9. For a resin that has been washed in sodium carbonate solutions, the loading factor is approximately 0.5 and it remains there, even if the resin is subsequently washed in deionized water. For a hydroxide washed resin the loading factor is 0. Washing in deionized water for a resin with a load factor above 0.5, will drive the loading state back down to 0.5. The excess CO₂ is either dissolved into the water, or released into the gas space outside the water film covering the resin. The ability to drive CO₂ off the resin with water forms the basis for our water swing, which is analogous to the pressure and temperature swings discussed above. This water swing is not limited to the use of liquid water, but just providing a high partial pressure of water vapor is sufficient for the resin to change its state from dry to wet.

Empirically, it has been shown that the equilibrium partial pressure of CO₂ over the resin is not only a function of the CO₂ loading of the resin, but it is also a very sensitive function of the partial pressure of water above the resin, and to a lesser extent a function of the temperature of the resin. The temperature, nevertheless, plays an important role, because it sets the maximum partial pressure of water vapor that can be reached above the resin. In order to reach a certain water loading on the resin by exposing it to water vapor, one needs a minimum partial pressure of water vapor, which in turn demands a minimum temperature. However, as long as the dew point of the gas mixture over the resin is below the ambient temperature, the dependence of the CO₂ equilibrium pressure at fixed loading and fixed absolute partial pressure of water vapor is only a weak function of the temperature. Causing a substantial unloading, nearly but not all the way to the carbonate point, is possible with water vapor pressures that can be reached at about 45° C.

Exposure to liquid water unloads the resin to approximately the carbonate point. The transition can be affected at ambient temperatures as well as at elevated temperatures and it can proceed without any change in temperature between the wet and the dry state. It is the presence of water in the resin that matters, and liquid water can drive the water content of the resin far more easily than water vapor.

The water sensitivity of the CO₂ absorption capacity is present even if the resin is washed in a carbonate or bicarbonate brine. Washing an air saturated dry resin in a sodium carbonate solution will remove CO₂ from the resin. If there is ample resin, one can change a half molar carbonate solution into a one molar bicarbonate solution, even though this solution is unstable in the presence of air and will eventually lose its CO₂ to the air while reverting to a sodium carbonate solution. In the absence of sodium carbonate in the solution, the CO₂ is still washed off the resin but pure water is unable to hold on to the CO₂ and will transfer it very rapidly into the gas space above the solution.

While the reactions proceed with air dry resins, the carbonate reactions involve water. Empirically, we have seen that if the resin is extremely dry it is unable to absorb CO₂. On the other hand, it is quite difficult to prepare a moisture free resin, and resin that has been exposed to air can be readily loaded with CO₂, even if the humidity surrounding the resin is very low, i.e. as low as one might expect in a desert climate. Unless aggressive means have been used to completely dry the resin there is always enough residual water for the resin to capture CO₂. The resin activity of a completely dried out resin recovers once the resin has been allowed to absorb water.

The observed humidity swing, i.e., the transition of a dry bicarbonate resin to a wet carbonate resin is counterintuitive. The mass action law of the carbonate to bicarbonate reaction suggests that the presence of water should drive the equilibrium in the opposite direction. This suggests that the actual chemistry is more complex than just the carbonate to bicarbonate reaction. As we will point out below, the thermodynamics of the process also suggests that the effect cannot be understood in terms of a simple carbonate reaction.

The present aspect of the disclosure provides a modular design with individual modules collecting one ton of CO₂ per day. This is equivalent to approximately 0.25 mol of CO₂ per second. At 1 m/sec effective air flow through the apparatus and 30% collection efficiency, the frontal area of the apparatus has to be approximately 50 m². The internal surface areas that take CO₂ out of the air are much larger and approach 10,000 m². This implies a surface area of 200 m² per square meter of wind area. This is not a very challenging surface area and can easily be supplied by a variety of shapes of the collector filter. The air collector is a set of passive units exposed to the wind stream which gradually become loaded with CO₂.

The dry resin, which has been loaded up with CO₂, can now be exposed to moisture, either in the form of low pressure water vapor, or directly to liquid water. The advantage of water vapor is that it is naturally clean and can be generated from brackish water, from seawater or from saline brines brought up from under the ground. The water input does not need to be cleaned. By contrast, liquid water that is directly brought in contact with the resin has to be reasonably clean as it would otherwise contaminate the resin. If there are anions other than carbonate or hydroxide in the water, they will replace the carbonate or bicarbonate ions loosely attached to the resin and thus inactivate the sorbent.

Since the overall process unavoidably releases moisture to the atmosphere, there is an advantage in using water vapor rather than liquid water. Saltwater or waste water streams are nearly everywhere affordable, while clean deionized water or condensation water is often not available, and would have to produced within the process. On the other hand, the use of liquid water, would simplify the process considerably and thus should be implemented wherever clean water is available. Most importantly, since liquid water can drive the water content of the resin up without having to go through a steam phase, there is no need for elevated temperatures, and hence no need for careful heat management. Furthermore, liquid water significantly speeds up the process. As a disadvantage, liquid water tends to increase water losses as the total water saturation of the resin tends to be higher. Thus the water losses during the drying stage of the cycle tend to be larger. It is, however, possible to reduce these losses, by carefully designing a water recovery system that attempts to recover much of the water before the resin is released from the vacuum of the regenerator box. Thus, there are advantages to both approaches.

Once the resin has been exposed to moisture in the form of water or water vapor, it will absorb some of the moisture. Once the higher moisture level has been established, the resin's ability to hold on to CO₂ is greatly reduced. As a result CO, will come off the resin and emanate into the closed container that surrounds the resin (State C). If air has been removed from the container, the gas content of the container is dominated by CO₂ and water vapor. A kilogram of resin is capable of exhaling several hundred liters of CO₂ at a backpressure of 0.1 bar. The product gas should be removed from the chamber, by pumping it out of the chamber and into a compression train.

While at the beginning of the release, the CO₂ partial pressure can be as high as 10 kPa, the equilibrium pressure over the resin drops rapidly as the resin begins to unload. It is therefore advantageous to design a counter-stream, or flow-through system where the CO₂ is swept from nearly depleted resin, over partially loaded resin to fully loaded resin, before it is transferred to the compression train. This results in a design where a number of chambers are plumbed together in a chain in which gas is transferred from one chamber to the next in a counter-streaming fashion, so that the most depleted resin first adds to the sweep stream of water vapor and the last and freshest resin tops off the CO₂ content in the exiting gas stream. This counter-flow arrangement makes it possible to produce a gas stream with far less fluctuation in the CO₂ concentration of the gas stream than would result from a single reservoir. In effect, we are using water vapor as a sweep gas to carry CO₂ from a one chamber to the next. Rather than moving resin loads from one chamber to the next, the valving between the chambers is arranged in a logical circle so that any chamber can be at the beginning of the chain and its next neighbor which could be downstream of it becomes the last chamber in the change. In the first chamber, the gas stream will be dominated by water vapor, in the last chamber from which the gas exits the dominant gas content is that of CO₂. The sweep is driven either by a pump that removes gas from the last chamber, or by maintaining a difference in water vapor pressure between the different chambers. See, e.g., co-pending U.S. Provisional Application No. 61/074,976, filed Jun. 23, 2008.

After the resin has given up the CO₂ it absorbed in the previous cycle it is allowed to dry. Drying could start in a chamber where moisture is allowed to condense against a “cold finger,” which drives the partial pressure of water down to ambient temperatures or below. The final stages of the drying process, however, will occur in open air. It has been shown that resins will spontaneously dry in ambient air to the point that they fully recover their ability to absorb CO₂ and thus re-enter the first step of the cycle.

The full cycle as described in FIGS. 1A-D will approximate a swing between the carbonate form and the bicarbonate form. Only this upper half of the loading factor is available to the humidity swing. Depending on the details of the implementation the total swing in the loading factor may be less then the full range from 0.5 to 1. For practical implementations we expect to reach a swing of about 0.1 to 0.2. In practical terms this amounts to a load swing of about 0.15 to 0.35 moles of CO₂ per kilogram of resin.

To perform a thermodynamic analysis, we may begin by laying out a hypothetical cycle that is clearly reversible and thus establishes the theoretical minimum energy input for the separation of CO₂ from air. In order to be specific one must carefully identify the inputs and outputs of the process. We consider in this discussion that there is an infinite supply of ambient air at a given temperature, and that one removes from this air a finite amount of CO₂. Hence the output is concentrated CO₂, but we do not produce CO₂ free air.

By providing a perfect semi-permeable membrane that allows CO₂ to pass through without friction, but completely blocks all other species contained in air, we can affect the separation of CO₂ from air, where the result is a volume of pure CO₂ on the permeate side of the membrane. This reservoir of CO₂ will have a pressure equal to the partial pressure of CO₂ on the input side. This transition happens spontaneously, it is fully reversible and will proceed in both directions without energy input to equalize infinitesimal pressure differences.

A virtually infinite supply of air on the other side of the membrane assures that the partial pressure of CO₂ in the throughput air can be considered constant. In the permeate chamber, CO₂ is removed by entering it into a compression chamber where it is driven to elevated pressure. We assume that the compression is isothermal, and hence reversible, and that it drives the CO₂ pressure from the initially low partial pressure, P_{g} to the desired output pressure P₀. The compression will have to be performed against a pressure difference of P(V)−P_{g}, and once the desired pressure P₀ has been reached, the volume will have to be pushed out of the pump, against a pressure difference of P₀−P_{g}. Hence the total work performed is expressed:

$$E = {P}_{0} {V}_{0} - {\int }_{{V}_{g}}^{{V}_{0}} P ( V ) d V - {P}_{g} {V}_{g}$$

The first term in the equation above represents the work done against the CO₂ gas as it is pushed at the final pressure into the CO₂ reservoir or pipeline, and the second term represents the energy expended against the backpressure of the CO₂ gas as it is isothermally compressed and the last term represents the work delivered by the constant pressure on the outside of the piston which is pushed forward by the pressure of CO₂ in the reservoir, which is at the low pressure Pg. The volume V₀ is the volume of the compressed CO₂, the volume V_{g} is the initial volume occupied by the CO₂ at its initial pressure which is equal to the equilibrium pressure of the CO₂ in the ambient air.

At low pressures (below 10 bar) CO₂ follows the ideal gas equation. In that case the first and the last term cancel, as both of them are equal to RT. Again for an ideal gas, the remaining term can be integrated and results in the standard formula

$$E = - RT ln ( \frac{{P}_{g}}{{P}_{0}} )$$

Using T=300K and P_{g}/P₀=4×10⁻⁴:

E=19.5 kJ/mol

Because the approximation shows this process is feasible, the energy input represents an upper bound on the work required to separate a minor constituent from another gas. Because this isothermal process is also clearly reversible, it also represents a lower bound, and hence it is the theoretical work required to separate the gas from the mixture. If the entire separation occurs at constant temperature and constant pressure, (i.e., P₀ is the ambient pressure of the input air), then the free energy change of mixing is the opposite of the work to separate the two gases, the enthalpy change for ideal gases is zero.

$$Δ G = RT ln ( \frac{{P}_{g}}{{P}_{0}} )$$

The thermodynamic analysis of the humidity swing becomes more complex in that it is affected not directly with input of mechanical energy, but through a secondary reaction that involves water. Thus the basic analysis of the core process is different in that the input and output states have changed. There is again an infinite supply of ambient air, with a low relative humidity, plus a supply of liquid water, the output state is slightly humidified ambient air with a tiny reduction in its CO₂ content and a separate stream of low pressure CO₂, admixed with water vapor. The input water has been consumed. For purposes of the theoretical analysis we will again assume that the air supply is virtually infinite, and hence its water vapor content and its CO₂ content are not changed. The liquid input water has been consumed and is released into the air. In a more practical variation, we consider the input water to be a salty brine, which results in a separate output stream of a more concentrated brine. For purposes of this discussion, we will ignore the corrections in the energy balance which will arise from the presence of these salts.

In total, the physical change of the system leads to a lowered free energy state, even though the separation of the CO₂ contributed a term in the balance with the opposite sign. The reduction in free energy is ultimately accomplished by liquid water evaporating into the air. This reduces the free energy as most air is not fully saturated in water.

While it may be counterintuitive that an endothermic reaction like the conversion of liquid water into water vapor can be tapped for energy extraction, it is nevertheless thermodynamically possible. The evaporation of liquid water in ambient air occurs spontaneously and hence must release free energy. A very simple device which harnesses this energy would be an evaporative cooler that creates a low temperature reservoir from the evaporation of water inside an atmosphere of dry air at a constant atmosphere. The temperature difference between the evaporatively cooled reservoir R1 and an ambient temperature reservoir R2, which is in close contact with unperturbed ambient air, can be used to drive, for example, a Stirling engine, which in effect produces mechanical energy from the drying out of a liquid water reservoir exposed to a dry constant temperature atmosphere. The lowest temperature that can be reached by evaporative cooling is given by the dew point of the input air, and hence we can calculate the maximum amount of free energy available per mole of water.

The thermodynamics of the process depend on the underlying reactions and we have shown, empirically, that in the range of conditions of interest one cannot deliver CO₂ above a pressure of about 10 kPa. The change in partial pressure of the CO₂ in effect provides an implicit measure of the free energy change of the reaction. As a practical consequence, the humidity swing by itself is insufficient to produce compressed CO₂ and further processing is required to separate the CO₂ stream from the associated water vapor and compress the CO₂ to the desired output pressure. We exclude this secondary compression step from the first step in the thermodynamic analysis and add it later for a full accounting as it only requires the input of external mechanical energy and can be easily accounted for.

We start with a dry ion exchange resin that absorbs CO₂ and releases this CO₂ again when the resin is exposed to moisture. The full thermodynamic cycle is closed by allowing the moist resin to dry against ambient air. Now the system is in its original state, but CO₂ has been separated from air and water has been evaporated.

Hence in an absorption/desorption cycle, it is possible to swing repeatedly between the “carbonate” and the “bicarbonate” form of the resin by moving from a nominally dry form of the resin, to a nominally wet form of the resin.

We denote the dry form of the resin as R_{D} and the wet form of the Resin as R_{W}. Again we know from observation, that if the humidity of the air is sufficiently low, R_{W} will turn into R_{D} under release of water vapor. To a good approximation what matters is the absolute humidity of the air.

Finally we observe that a dry resin R_{D}, which has been exposed to ambient partial pressures of CO₂ and therefore has loaded up with CO₂ nearly to the bicarbonate form of the resin, will be in equilibrium with a partial pressure that can reach as high as 10 kPa of CO₂ when wetted. The maximum partial pressure of CO₂ depends on temperature and on the amount of water provided.

As a result the partial pressure of CO₂ has been increased by a factor of about 200 by a physical change in the state of the resin, involving the conversion of dry resin to wet resin. This change is itself reversible and exposure of this resin to air will recover the dry resin the cycle started with. If we assume a typical relative humidity of 50%, then the evaporation of water releases free energy, which is given by RT ln(2), whereas the free energy of the CO₂ increased by RT ln(200). Hence, the state change of the resin is not a competition of a single water molecule for the CO₂ site, but a number of water molecules being absorbed onto the resin change the physical state of the resin in such a manner that the CO₂ is released. The minimum ratio of H₂O to CO₂ involved in the transition depends on the exact ratio by which one can drive the CO₂ concentration up. For a ratio of 200, the water to CO₂ ratio is at least 7.6 moles of water per mole of CO₂, or a mass ratio of 3.1 to 1. Based on current experimental data we have not yet achieved this level of efficiency.

Since it is the transition of water from the liquid state to the vapor state that provides the thermodynamic drive, the consumption of water is unavoidable. Nevertheless, the process we have designed does not consume fresh water, it consumes salt water and produces as a byproduct fresh water. The fresh water results from the condensation of left over water vapor. The total amount can vary with design details but is typically less than half a ton of water per ton of CO₂.

Experiments have shown that there is a continuum of intermediate states. A small increase in water vapor over the resin will lead to a small release of CO₂. It is therefore possible to chose among a large variety of different operating conditions. Different systems will represent different trade-offs between water cost, energy cost and the value of the drinking water by-product. Empirically, the water losses appear somewhat higher than the minimum water loss demanded by thermodynamics. Typical values range from, 5 and 15 times the weight of CO₂ which leads to 12 to 37 molecules of water per molecule of CO₂.

In conclusion, it is possible to pay a large fraction of the energy bill for producing air free CO₂ by transferring water from the liquid state into the vapor state. In effect we are tapping into the energy that is derived from drying wet materials in open air. We are not paying energy for the evaporation of water, we take advantage of the fact that this process happens spontaneously and that the heat of evaporation is taken from the ambient environment.

The resulting CO₂ stream is mixed with water vapor and has a total pressure between 5 and 20 kPa. This gas stream requires further compression to condense out the water and deliver the CO₂ in a compressed stream. The compression energy will be discussed in the following section.

The following discussion summarizes the various energy input and outputs. We distinguish between thermodynamically necessary energy expenditures, which put a hard limit on the system's energy demand, and practical energy consumption that is based on current designs, and in some cases could be greatly improved over time.

The air collector in our designs is passive, and the only energy consumption here is associated with the motion of the resin air collectors from the regenerator system to the collector. Our current estimate is that we are spending on the order of a kJ per mole on operating machinery, but of course thermodynamically there is no required input here.

Energy is directly consumed in collecting the resin into a chamber where the air is pumped out before the resin is exposed to moisture. In any practical implementation, pumping air out of an enclosure requires some energy. Given a load swing of about 0.25 mole/kg of resin, and a filter packing of about 100 kg of resin per cubic meter, we can get 25 mole of CO₂ from a resin chamber with a volume of 1 m3. Since the evacuation of a cubic meter requires 100 kJ of energy, the evacuation would typically cost 4 kJ/mole of CO₂. Inefficiency may drive this number up to 6 kJ/mole. However, it is possible to greatly reduce this energy cost, as one can take advantage of the mechanical energy that is gained by refilling a chamber with air. In an ideal implementation the energy collected in the air refilling of the chamber could completely pay for the energy required in the evacuation. From a thermodynamic point of view it is therefore possible to ignore this term, from a practical implementation at least some energy is consumed here, and for our first implementations we will assume 6 kJ/mole. Over time we expect to reduce this loss.

Energy is consumed in the transformation of water-vapor rich, low pressure CO₂ into high pressure, dry CO₂. The pressure of the gas is given P═P_{CO}_{₂}+P_{H}_{₂}_{O}. During an isothermal compression the water vapor pressure remains constant, and the amount of residual water vapor is reduced as the total volume of the gas is reduced and the excess water vapor condenses out. Depending on the exit temperature of the gas, the partial pressure of the water vapor can range from 1 to 10 kPa. The CO₂ partial pressure will vary between 1 kPa and 10 kPa and through a counterstream sweep will be built up to between 5 and 10 kPa. The two partial pressures are highly design dependent and not necessarily correlated. However a high water vapor pressure combined with a low CO₂ pressure would represent a bad design and it is therefore assumed that a practical implementation will not operate in this parameter range.

A high water vapor pressures would arise in systems in which one attempts to transfer heat into the regenerator and is taking advantage of the fact that the water vapor compression takes very little energy but will release a large amount of heat in the condensation. The heat of condensation is 43 kJ per mole (at 45° C. or 318.15 K). The compression of 1 mole of water vapor by essentially its entire initial volume will consume RT in energy if the water vapor is saturated at the start of the compression. Around 300K (26.85° C.), this amounts to 2.5 kJ of mechanical energy, and over the practical range of possible temperatures this number may vary by about 10%. In any case, the coefficient of performance of such a heat engine is excellent. It is for this reason possible to use water vapor compression to preheat a cold dry resin filter that enters the regeneration system.

Hence the first thermodynamic energy penalty is 2.5 kJ per mole of H₂O, where we can assume that in a practical design it takes less than one mole of H₂O per mole of water. If there is no heat demand in the system, and no water demand, the amount of water produced per unit of CO₂ can be reduced to between 10% and 50% of the moles of CO₂. In a practical implementation we consider this energy penalty to be between 1.5 and 2 kJ of mechanical energy input. This allows for mechanical inefficiencies on the order of 25%.

It takes 18.7 kJ to compress the dilute CO₂ gas in the chamber to liquid CO₂ at the end of the compression train. We assume a temperature of 300K an initial CO₂ pressure of 5 kPa, and a final partial pressure over the liquid of 6713 kPa. We assume a liquid density of 679.3 kg/m3 and will compress all the gas phase CO₂ into the liquid. The energy consumption exceeds the compression energy of 17.9 kJ necessary for the compression of an ideal gas to the same final pressure and it is less than the 22.2 kJ necessary to compress the ideal gas to the same final volume. Most of the deviation between the real equation of state and the ideal equation of state occurs at pressures above 1000 kPa. It is worth noting that the isothermal compression produces useful heat that can be used elsewhere in the process. The heat output exceeds the mechanical work done on the system.

The work to liquefy the CO₂ starting from 100 kPa is 11.3 kJ. This compression work is the same for most air capture processes or even flue stack capture of CO₂. We are assuming an overall efficiency of 67% for the pump. Some of this is attributed to the inefficiency of the electric conversion and the internal friction of the device, some of the inefficiencies are due to the deviation from an isothermal compression. By comparison with standard designs, this assumption is conservative.

Heat management, is not part of the thermodynamic analysis, as in a perfect system there is no heat demand, yet the system has to move heat between various reservoirs and the total internal heat transport inside the regenerator is large, even though the net transport cancels out. Even though any heat inputs would be extremely low grade heat and hence not very expensive, it is nevertheless important to account for them, as in most locations heat is not readily available and would have to be produced by some mechanism. From a thermodynamic point of view, there is no heat demand. From a practical point of view, some heat input is required to maintain the system at slightly elevated temperatures, as some heat will inevitably dissipate from the system. The heat that is generated within the regeneration process is sufficient to cover heat losses.

There are two major heat sinks in the process that need to be considered. One is the heat content of the sorbent system, which has a hundred times the mass of the captured CO₂, and the heat of evaporation of water which also could amount to about 10 times as much mass as the CO₂. Assuming a typical heat capacity of 1 kJ/(kg K) for the sorbent material and a CO₂ unloading of 0.25 mole per cycle, we require 4 kJ/mole of CO₂ per degree of heating. Hence the heat capacity of the resin represents a reservoir that could be on the order of 100 kJ/mole of CO₂. The heat of condensation of the water is even larger, the total energy involved here is on the order of 1000 kJ/mole of CO₂. A solar heat collector to support these kind of heat flows would completely dwarf our system. Fortunately, these heat sinks are to first order balanced out against heat sources and to second order they are over compensated for with energy inputs and thus do not represent real net heat demands. Nevertheless, the movement of so much heat needs to be carefully planned, and adequate pathways for those heat flows must be provided.

In a humidity cycle, water evaporates inside the evacuated chamber and is re-absorbed inside the chamber onto the dry resin. Based on our preliminary experimental data, the total cycle is slightly exothermic. This is also expected on the basis of thermodynamic arguments: the resin readily absorbs water from the air, therefore the free energy of absorption must exceed that of water condensation, as the air is still undersaturated in water vapor. The difference is likely to be in the enthalpy term, as the entropy change is dominated by the high entropy of water vapor. The evaporation of water will consume heat inside the regenerator, and the absorption of the same water on the resin will release an equal or slightly larger amount of heat. A large amount of heat that needs to be transferred within the chamber between the site of the water evaporation and the site of the water absorption, but net total the energy is balanced out, with a slight excess energy, which can help maintain an elevated temperature in the system. For a collector capable of capturing one ton of CO₂ per day, internal heat fluxes, which net out to zero, could be as large as 250 kW. Heat transfer on this scale is not unreasonable; a simple car radiator can easily discharge 30 kW of heat, and while it benefits from much higher speeds of air flows, it also has a much smaller cross section to work with.

In a wet water cycle, there is no water evaporation, yet there is still transfer of water to the resin. The net reaction has the same thermal output as before, but this time the large internal heat transfer has been eliminated. Nevertheless, a water based system will be able to maintain operation at an elevated temperature.

The small fraction of the water vapor that is not absorbed by the resin material but is mixed in with the CO₂ product gas could carry some latent heat out of the system. However, nearly all of this water vapor will be condensed out during the pressurization of the CO₂. Therefore, the loss of latent heat is completely recovered in the early stages of the compression. The compression acts as a heat pump that takes heat from one part of the regenerator and deposits it in another. Heat in the chambers is transformed at one temperature into latent heat and released at a higher temperature in the compressor system. Water losses as opposed to latent heat losses are associated with water that has been captured by the resins and are carried out into the ambient air where it will evaporate under input of heat from the ambient background. These water losses have no associated energy loss.

Unfortunately, this heat pump is internal to the regenerator system and does not bring in ambient heat from the outside. The process therefore can help maintain a temperature gradient within the system, but it cannot pump ambient heat into the overall process. Nevertheless, the system has a net heat input from the mechanical compression work that adds up to about 20 kJ/mole of CO₂ back into the system. In effect, we have a 5 kW heater for the regeneration system, which at a volume of 25 m3 is the size of a small room. Clearly, it does not take much insulation to keep the interior of the vacuum chamber at an elevated temperature.

In order to maintain an elevated temperature, it is important to avoid all ways by which heat can escape from the regenerator system. A potential heat loss on the order of 100 kJ per mole of CO₂ arises from bringing loaded resin in at a low temperature and returning it back to the collector at an elevated temperature. This heat loss can be completely eliminated by pumping water vapor out of the last chamber right before the resin is released again. As a result the wet resin will release water vapor and thus heat stored in the resin is transferred into latent heat that remains available within the regenerator system. As a consequence, there is very little heat loss due to transferring resins out of the system. Indeed it is possible to overcompensate, and let evaporative cooling drive the temperature of the resins below ambient temperatures before they are removed. This results in a system that in effect pumps heat from ambient conditions outside, into the regenerator at elevated temperatures.

It is also possible to pump some additional heat into the system, by assuring that a fraction of the water vapor available to the system has been raised against ambient heat. As fresh resin is put into a chamber, the chamber is first evacuated and then water vapor from a water vapor reservoir at ambient temperature should be pulled in, before the system is given additional water vapor in equilibrium with higher temperature reservoirs. The small fraction, maybe ten percent, of the water that has been derived from this source, carries with it latent heat that has been extracted from the ambient environment. It is this heat which is later pumped to higher temperatures when the exhaust gas from the system is compressed and the water vapor is forced to condense out.

All told there is substantial amount of heat flow internal to the system that is carried with water vapor as latent heat. This is particularly true of systems operating with a vapor based humidity swing. To counter theses streams it is necessary to carry heat in the opposite direction. While large, these flows are manageable and can be easily carried by a liquid coolant interacting with the various parts of the system, or even better by an evaporation cycle, i.e. a heat pipe. To set the stage, using water as a coolant, a 250 kW heat transport would require a water flow of 12 liters per second with a temperature change of 5K. Heat pipes provide a much better way of transferring heat and could carry most of the demand.

A liquid water swing is a viable alternative to a water vapor swing. Because it has many advantages, it should be considered in its own right. In this case we would need to prepare all of the makeup water as clean water, and therefore the air capture device, would have associated with it a water preparation system. Condensation water is certainly adequate and would be the obvious choice in horticultural applications, another option is to use exchange resins to remove anions from the mix. For river water or lake water, which has relatively small salt content, one would consider anionic exchange resins, combined with an electrodialysis station to create washing fluid that is essentially free of anionic contaminants. It is not necessary, to remove the last amount of anionic contaminants from the wash water; a small addition of sodium carbonate to the water would overpower the presence of small amounts of other anions. Elsewhere we have discussed a variety of options to clean up the water stream. However, for purposes of this discussion we simply compare to seawater desalination which can be performed with energy input of 13.2 MJ per ton of water. If we were to use 10 tons of seawater per ton of CO₂, the energy consumption could be as high 130 MJ of energy per ton of CO₂. This would add about 6 kJ of electric power per mole of CO₂. Hence the use of the liquid water swing could still rely on non-potable water and create clean water as it is needed.

The following table summarizes the various uses of energy

TABLE 1
The Energy Summary.

| | Thermo- | Mechanical | Electrical | | Fraction of CO₂ re- | |
|---|---|---|---|---|---|---|
| | dynamic | Work | Power Input | | emitted at power plant | |
| | kJ/mol | kJ/mol | kJ/mol | kJ/kg | Coal | NG |
| CO₂ Compression | 18.73 | 18.73 | 27.96 | 635 | 16.8% | 10.6% |
| Regenerator | | | | | | |
| Evacuation | 0.00 | 4.00 | 5.97 | 136 | 3.6% | 2.3% |
| Water Vapor | | | | | | |
| Compression | 2.0 | 3.0 | 4.48 | 102 | 2.7% | 1.7% |
| Mechanical motion., | 0.00 | 0.15 | 0.30 | 7 | 0.2% | 0.1% |
| pumping etc. | | | | | | |
| Water Preparation | 0.00 | 1.14 | 5.81 | 132 | 3.5% | 2.2% |
| Total | 20.73 | 27.02 | 44.51 | 1012 | 26.8% | 16.9% |

The table accounts for all external inputs. Heat inputs are generated from the mechanical inputs considered here and are therefore not separately listed.

The CO₂ compression represents the thermodynamic work required to compress gaseous CO₂ from 5 kPa to liquid density at 300K. The actual compression energy may vary slightly depending on temperature. All of the thermodynamic input is mechanical work, we assume a 67% efficiency for the pumping process, which allows for pump inefficiencies and deviations from the isothermal compression in a multistage compression. The assumed overall efficiency is slightly lower than that described in McCollum and Ogden (2006). The regenerator evacuation can be accomplished thermodynamically without energy input, for a practical implementation we assume 4 kJ per mole of CO₂, which is based on the observation that a cubic meter of loosely packed resin material can deliver 25 mole of CO₂ and requires 100 kJ for its evacuation, again we assume 67% efficiency in performing this task. Water vapor compression is necessary to separate CO₂ from water vapor. The amount of energy required per mole of H2O is RT, the water to CO₂ ratio is assumed to be 3:4. In the mechanical work we account for an additional water compression that is necessary to cool the resin off before it leaves the regenerator unit. For this we expect to evaporate approximately 1 mole of water from the resin material and drop the vapor pressure in half. This would require an energy input of RT(1−ln(2))=0.8 kJ, we have rounded the total mechanical energy input to 3 kJ/mole of CO₂. Mechanical motion of the materials, water pumping etc, are small, here we assume that on a one ton per day unit, we need to lift 5 tons of resin 12 times by 3 meter, and that 10 tons of water are pumped up by 10 meters. We assume that we require twice as much electric input. Water preparation is only an issue for a liquid water based process, it does not add to the thermodynamic limit, but is included with its theoretical minimum in the mechanical work required. The number is based on 10 tons of water per ton of CO₂ and a osmotic pressure of seawater of 2.6 MPa. The electric input, which is far larger, is based on the actual energy input at the new water desalination plant at Perth, Australia. The total electric energy is represented in kJ/mole as well as in kJ/kg (or MJ/ton). We assume as has been explained elsewhere in the text that heat management makes it unnecessary to introduce additional heat into the system. In the last two columns the fraction of the CO₂ that is in effect re-released at the power plant is estimated based on a 1999 US Coal Plant and on a 1999 US Natural Gas Fired Power Plant.

Another aspect of the present disclosure employs similar methods of heat transfer to a sorbent that is regenerated by a thermal swing. According to this aspect of the present disclosure, the process employs an apparatus including a capture unit 110 and a regeneration unit 120, having a sorbent material 101 that can be moved 111 from one unit to the other. See FIG. 2. For the purposes of the present disclosure, the sorbent material may be a liquid that can absorb CO₂, such as for example, a sodium hydroxide solution, a sodium carbonate solution, or an amine solution; or may be a solid, such as for example, solid amine resins or other ion exchange resins.

While in the capture unit 110, the sorbent 101 is exposed to a gas stream containing a contaminant, such as CO₂. The gas stream may be, for example, ambient air or an exhaust stream from an industrial process. A filtered stream 103 exits the capture unit with a substantially depleted carbon dioxide content.

The regeneration unit 120 should be maintained at a temperature T₁, where T₁ is greater than Tₐ, wherein Tₐ is the ambient air temperature. For example, T₁ preferably is at least 20° C. above Tₐ. The sorbent material in the capture unit must be brought into the regeneration unit to release the CO₂. The regeneration unit raises the temperature of the sorbent to release the CO₂, resulting in off stream 140 with a high concentration of CO₂. Then the sorbent material is returned to the capture unit. This thermal swing may be, for example, a rise of up to about 100° C. above ambient temperatures. The heat required to maintain the regeneration unit at temperature T₁ may be supplied by a heat reservoir 135, such as the ground or a water reservoir, or may be provided from other sources, including but not limited to solar energy, geothermal energy, or waste heat from other processes, such as for example power plants, steel mills, and/or cement plants.

In order to avoid any unnecessary losses, heat from the sorbent can be returned to the regeneration unit before the sorbent is again exposed to ambient air, thus conserving energy.

This may be done, for example, by evaporating water into an evacuated space. The water vapor contains the latent heat of evaporation, and if the water is compressed at a higher temperature it will release its heat content at the higher temperature. One way to bring about this transition is to let the water condense onto the surfaces of the sorbent. This may be counter-productive in some instances, however, as the presence of water may interfere with the CO₂ release of some sorbents.

For sorbents where contact with water is unacceptable, there may be other working fluids that could be deployed in a similar manner. In such case, it is important that the working fluid itself does not interfere with the release of CO₂ from the sorbent, and that it can readily be separated from the released CO₂. Water is a good choice for most sorbents because the water will condense out under compression and thus is easily separated from CO₂. CO₂ as a working fluid would not require a separation from the product CO₂, but it would of course interfere to some extent with the process of releasing CO₂ from the sorbent. Nevertheless, it is possible to remove the bulk of the compressed CO₂ at high pressure, and reduce the volume of residual CO₂ so much that the subsequent expansion does not provide enough heat mass for the resulting temperature drop to effectively cool the chamber or the sorbent material inside of it.

In each of the examples discussed above, it also is possible to isolate the working fluid from the sorbent, in which case the working fluid may be used to transfer heat from the ambient conditions, or from the elevated temperature of the regeneration unit to the CO₂-loaded sorbent material that is about to enter the regeneration unit. It also is possible to effectuate some of the transition by transferring heat directly from warm, regenerated sorbent down a natural temperature gradient to cold, CO₂-loaded sorbent. Further, where the working fluid is isolated from the sorbent, the choice of an optimal working fluid is not limited to water. It could, for example, be CO₂ which in near ambient conditions has been identified as a good choice of a refrigerant. Other conventional refrigerants, such as R-12 or R-22, are also viable in this arrangement.

The examples outlined above are illustrated by FIG. 2, which includes a heat exchange loop 130, carrying a refrigerant, such as water or another working fluid, from the capture unit 110 to the regeneration unit 120, and back again. For example, water may be evaporated in or near the capture unit 110, thereby retaining heat and the heat containing fluid 131 can then be transferred to the regeneration unit. The water condenses in or near the regeneration unit and returned to the capture unit as a heat-depleted fluid 132, completing the cycle.

This aspect of the present disclosure therefore provides a sorbent that absorbs a gas, such as CO₂, under controlled temperatures, and will load itself fully or partially with the gas it is absorbing. At the time the sorbent enters into the recycle loop we refer to it as the loaded sorbent, even if the loading does not reach the maximum level that is achievable. The sorbent is recovered at an elevated temperature, the goal of this disclosure being to provide the heat necessary to drive the sorbent to the higher temperature. It is implicitly assumed that the heat required to release the gas is also provided but that in the typical case this is small compared to the heat required to warm the sorbent. Whether or not this amount of heat can be considered small, in heating up the sorbent, it is understood that this heat is provided as well.

In another aspect, the present disclosure extracts carbon dioxide from ambient air using a conventional CO₂ extraction method or one of the improved CO₂ extraction methods disclosed in our aforesaid PCT Applications, or disclosed herein, and releases at least a portion of the extracted CO₂ to a secondary process employing CO₂. The CO₂ also may be extracted from an exhaust at the exhaust stack.

In our co-pending U.S. application Ser. No. 11/866,326, assigned to a common assignee and incorporated by reference herein, there are provided methods and apparati for extracting carbon dioxide (CO₂) from ambient air and for delivering that extracted CO₂ to controlled environments. Specifically, the aforementioned applications disclose the delivery of CO₂ collected from ambient air or from exhaust gases for use in greenhouses or in algae cultures. The CO₂ is extracted from the gas stream by an ion exchange material that when exposed to dry air absorbs CO₂ that it will release at a higher partial pressure when exposed to moisture. In this process we can achieve concentration enhancements by factors of from 1 to 100.

The resins discussed above and disclosed in our previous U.S. Provisional Patent Appln. 60/985,586 and PCT International Patent Appln. Serial No. PCT/US08/60672, assigned to a common assignee and incorporated by reference herein, make it possible to capture CO₂ from the air and drive it off the sorbent with no more than excess water vapor.

In this aspect of the present disclosure, an improved method for extracting and concentrating CO₂ is provided, wherein liquid nitrogen is used as a form of energy storage. In co-pending U.S. Provisional Application 61/074,972, assigned to a common assignee and incorporated by reference herein, there is described a method and apparatus for extracting CO₂ from ambient air and for delivering that extracted CO₂ to a secondary process in a form that is required for the secondary process, which may be gaseous, solid, or liquid CO₂. However, the amount of energy required for concentrating the CO₂ and delivering it in a form that is suitable for a given secondary process may be cost prohibitive in some cases.

In extracting and concentrating CO₂ using a humidity swing, most of the energy that is consumed is mechanical energy, e.g. in the creation of a vacuum around the resin to isolate the CO₂ and water vapor during the regeneration of the resin. It also is possible to design some of the steps of the process, so that they are based on refrigeration of the CO₂ stream down to about −120° C. This we refer to as cryogenic compression. In either case liquid air or liquid nitrogen could provide a medium of storing this energy prior to the availability of CO₂. In other applications, liquid nitrogen has been suggested as a relatively compact fuel for cars, where one takes the liquid nitrogen and lets it boil off and drive a piston by expanding against open air. A disadvantage of employing liquid nitrogen as a fuel is that it is inefficient to produce relative to fossil fuels. In this application, however, we utilize the thermal capacity of liquid nitrogen and apply it CO₂ compression with great efficiency.

The energy density of liquid nitrogen is similar to the energy density we obtain in the product stream using a humidity swing process. Hence a container full with several cubic meters of liquid air or nitrogen could drive a CO₂ one ton per day capture device such as described in our U.S. Provisional Appln. No. 61/074,976, the contents of which are incorporated herein by reference, for an entire day. The iso-thermal expansion of air by a factor of 680 provides approximately 500 kJ of mechanical energy that could be extracted from the system as it warms up to ambient conditions. This is about 17 kJ per mole and thus mole-for-mole comparable to the amount of energy that would be required to operate the system. A typical one ton per day CO₂ capture unit would need several cubic meter of liquid air to operate without electricity for a day.

The heat of condensation can be used to freeze CO₂ providing another way of using the low temperature directly. The advantage of this approach is that it is extremely efficient because virtually all the heat that is transferred to the liquid nitrogen contributes to the overall process of generating compressed CO₂. If instead we were to use conventional refrigerators, or for that matter compressors, the process would incur approximately the same cost in terms of inefficient energy use that that would be seen in producing the liquid nitrogen. Hence, liquid nitrogen as an energy storage is particularly well suited to this application as it in effect makes it possible to store a large fraction of the energy that is needed up front. Hence intermittent sources of electricity can be considered, such as for example wind energy or solar energy, and used to produce a large reservoir of liquid nitrogen that can later be applied to producing and compressing CO₂. It thus makes it possible to operate the air capture devices 24 hours a day, even if the electricity supply is intermittent, or undergoes large price fluctuations.

In addition, air capture can therefore contribute to the stabilization of the power grid in the presence of large intermittent sources of power, or for that matter in the presence of a large number of baseline power plants that during low demand hours have to sell their electricity at a low price.

In an alternative example, a method is provided for generating mechanical energy from liquid nitrogen to run pumps and compressors in an air capture device. In another aspect of the disclosure there is provided a method of operation that relies on cryogenic compression of the CO₂ that can use, e.g., liquid nitrogen as a medium of heat exchange.

In some implementations, liquid air or nitrogen can be employed as the working fluid in the refrigeration system and it is used to carry heat away from the CO₂ cooler. For example it is possible to boil liquid nitrogen to remove heat from the system. By regulating the pressure one can adjust the boiling temperature to suit the problem. The resulting pressurized cold fluid is then used either to pre-cool CO₂ entering the apparatus, or in another implementation to create mechanical energy by expansion. It is, of course, also possible to combine the two functions in a single system.

In other implementations the liquid nitrogen acts strictly as a secondary cooling system that is used if electricity at the moment is in short supply and that is replenished whenever electricity is in oversupply.

In any system that is based on cryogenic compression, it still may be advantageous to lower the high partial pressure of water at least initially in a mechanical step. In all cases, one needs to optimize between compression that drives water off at temperatures above ambient, possibly at a temperature that makes the heat of condensation useful, condensation against ambient temperature, and compression that utilizes very low grade cold which otherwise would be wasted, and finally refrigeration power to remove water from the gas stream. Until the partial pressure of CO₂ to H₂O favors CO₂ by a large factor—e.g., five to ten—compression has an advantage that it is far more energy efficient. But eventually condensing out residual water vapor is more energy efficient than the additional compression of a large volume of CO₂. This is particularly true if one intends to cryogenically compress the CO₂ in any case, and in cases where there are still noticeable amounts of non-condensible impurities in the CO₂. Cryogenic compression is indicated if the goal is to produce dry ice, but it is also advantageous if the resulting CO₂ product has to satisfy high standards of purity.

The actual operation of the system utilizes liquid air for mechanical compression steps as well as for cryogenically cooling CO₂. The advantage of such a system is that with a small storage tank of cryogenic air, we can transform our device into a peak energy saving system, or alternatively run on more or less dedicated windmills or solar panels, as we have solved the storage issue in the context of our application.

An advantage in utilizing liquid nitrogen energy storage over conventional energy storage systems that aim to regenerate the electricity is that the present disclosure provides the energy in a low temperature reservoir in a form that can be applied with only minor losses in the subsequent steps. Furthermore, if we limit the work to cryogenic compression and clean up, the inefficiency in producing liquid air is acceptable as the equivalent compression or refrigeration of the CO₂ gas stream has comparable inefficiencies. The subsequent utilization of liquid nitrogen as a means of cooling the gas stream is very efficient and thus loses relatively little energy. Thus, we can think of the liquid nitrogen as stored refrigeration or compression in which case its efficiency as a storage medium is very high.

Another aspect of the present disclosure provides additional technologies to optimize the use of fresh water in air capture of carbon dioxide. Commonly-owned, co-pending U.S. Application No. PCT/US08/60672, Ser. Nos. 12/265,556, and 12/389,213, incorporated by reference herein, disclose state of the art methods and apparatus for Air Capture of carbon dioxide utilizing a supply of fresh water for the recovery of carbon dioxide from a sorbent and the refreshment of the sorbent, such as an ion exchange resin, for the next carbon dioxide collection cycle. The overall process involves wetting the resin for example, by exposure to humid air, immersion in water or exposure to short pulses of steam. Thus, the processes are dependent on the availability of a fresh supply of water. However, the availability and use of fresh water for carbon capture is necessarily in competition with other industrial, commercial, agricultural and residential uses. Therefore, it is desirable for economic and environmental reasons to pursue strategies to minimize the consumption of fresh water and thus maximize the economic efficiency of air capture of carbon dioxide.

An efficient way to manage water use is to recover and reuse as much water as is possible. The afore-mentioned commonly-owned applications provide, as a product of the process, a gas product stream that is a mixture of carbon dioxide and water vapor. One way to recover the water component of that stream is to compress the stream and force the water to condense out of the compressed gas. This process consumes energy in compressing the product stream, causing an inherent inefficiency in the process.

An alternative method for condensing water out of the process gas stream is to cool the stream and remove the water through condensation as the dew point matches the temperature of the gas stream. The present disclosure provides a method for using a plentiful resource to provide the cooling necessary to cool the process stream sufficiently to remove, recover and reuse the water in the carbon capture process cycle.

Referring to FIG. 3, in the present disclosure, saline brine is pumped from shallow saline aquifers to wet an absorbent outer covering of the product stream containment vessel. The vessel can be configured in any of a variety of geometries and should be optimized for the location of use. Since we will most likely be operating in an arid environment, the brine will evaporate off of the absorbent covering, cooling the covering and the containment vessel within. This cooling will be sufficient to condense out the fresh water from the product process stream for recovery and reuse.

The saline brine which, over time, will increase in salinity, will need to be refreshed with a brine of lower salinity pumped from the aquifer. The high salinity brine can be utilized in one of several commercial enterprises know to individuals familiar with the art. For instance, there is interest in using saline brine from these aquifers to provide a source of clean salt water, free from contaminants and pathogens for intense marine aquaculture (U.S. Pat. No. 6,986,323 B2). The state of the art for this use is to pump the water from the lower reaches of the aquifers in order to reach water with sufficiently high salinity. This increases costs due to high pumping heads and higher pressures. Combining the use of shallow, low salinity brine, with the concentration effect of evaporatively cooling the air capture process stream, water of the correct salinity can be provided at a much lower cost with reduced pumping costs.

Additionally, the high salinity brine discharge from the aquaculture could be processed evaporatively into salt which has a variety of commercial uses including winter deicing of roads, etc. The high salinity brine waste also might be pumped back into a deep saline aquifer where it will harmlessly mix for eventual reuse.

While a traditional cooling tower can also provide a supply of evaporatively cooled water, this disclosure works without the need for dangerous and expensive water treatment chemicals, nor does this disclosure require fans to force the evaporative air through the system, relying instead on natural wind flow.

For purposes of this disclosure, brine is also used to refer to contaminated water that is otherwise unsuitable as fresh water, such as for example, waters contaminated with biological waste materials.

It should be emphasized that the above-described embodiments of the present device and process, particularly, and “preferred” embodiments, are merely possible examples of implementations and merely set forth for a clear understanding of the principles of the disclosure. Many different embodiments of the disclosure described herein may be designed and/or fabricated without departing from the spirit and scope of the disclosure. For example, while the present disclosure is directed to the capture of CO₂, as noted above, the technology disclosed herein may be applied to the capture and sequestration of other contaminants, including sulfur dioxide, hydrogen sulfide, nitrogen dioxide, ammonia, or particles. All these and other such modifications and variations are intended to be included herein within the scope of this disclosure and protected by the following claims. Therefore the scope of the disclosure is not intended to be limited except as indicated in the appended claims.

1-19. (canceled)

20. A method for capturing carbon dioxide from a gas stream, comprising passing the gas stream in contact with a sorbent to absorb carbon dioxide, releasing capture CO₂ from said sorbent to form a gas mixture having enhanced concentration of carbon dioxide, and using an amount of liquid nitrogen or liquid air to cool the gas mixture, thereby condensing out a component of the gas mixture.

21. The method of claim 20, wherein the liquid nitrogen or liquid air is contained in a supply reservoir that is used as a form of energy storage.

22. The method of claim 21, wherein the liquid nitrogen or liquid air is produced using an intermittent power supply.

23. A method for capturing carbon dioxide from a gas stream, comprising passing the gas stream in contact with a sorbent to absorb carbon dioxide, regenerating the sorbent via a humidity swing to form a gas mixture substantially comprising carbon dioxide and water vapor, and condensing the water vapor out of the gas mixture by first absorbing heat into a separate water supply and then absorbing additional heat into a heat sink containing a supply of liquid nitrogen, liquid carbon dioxide, or liquid air.

24. The method of claim 23, wherein the water vapor forms ice after it condenses.

25. The method of claim 24, wherein the ice is used to absorb some of the heat from additional gas entering the drying process.

26. The method of claim 23, wherein the temperature of the incoming gas is lowered to a temperature of between −40° C. and −90° C., at which point virtually all the remaining water is removed.

27. The method of claim 23, further comprising using liquid nitrogen and dry ice to cool the remaining carbon dioxide to form dry ice, compressing the dry ice, and enclosing the dry ice in a pressurized container to convert the dry ice to liquid carbon dioxide.

28. The method of claim 26, wherein a heat transfer below those temperatures which can be reached with external water evaporation is at least partially provided by a counter-stream utilizing the remaining relative heat capacity of evaporated liquid nitrogen or evaporated liquid air.

29. The method of claim 27, wherein a heat transfer below those temperatures which can be reached with external water evaporation is at least partially provided by a counter-stream absorbing the energy into the pressurized container as the dry ice melts into liquid carbon dioxide.

30. A method as in claim 23, wherein at least some of the liquid nitrogen or partially warmed up nitrogen is allowed to reach elevated pressures as it is warming up, and where the resulting elevated pressures are used to drive pistons, turbines or similar mechanical gear which is used to create mechanical energy for operating mechanical equipment.

31. The method of claim 30, wherein mechanical equipment is used for compression of gases or for the movement of gases from one chamber to another.

32. The method of claim 20, wherein a refrigeration unit is attached to the reservoir and is operated to produce liquid nitrogen or liquid air based on the need for more liquid air or nitrogen and the current availability of electricity.

33. The method of claim 23, wherein the step of condensing the water vapor out of the gas mixture is at least in part performed by a refrigeration unit when sufficient electricity is available.

34. The method of claim 33, wherein the refrigeration unit is used to produce additional liquid air when the available electricity exceeds the demand of the air capture unit.

35. The method of claim 34, wherein the water vapor is condensed out of the gas mixture using whatever source is most readily available.

36. A method for removing and sequestering a contaminant contained in a gas stream, comprising:
bringing said gas stream in contact with a sorbent material, wherein the contaminant attaches to the sorbent material;
wetting the sorbent material to release the contaminant to an off-stream; and
removing water vapor from the off-stream by passing the off-stream through an evaporative cooling chamber, wherein the off-stream is cooled by the evaporation of a fluid external to said evaporative cooling chamber.

37. The method of claim 36, wherein the contaminant is one of a group consisting of carbon dioxide, sulfur dioxide, hydrogen sulfide, nitrogen dioxide, and ammonia.

38. The method of claim 36, wherein the fluid is a low-temperature brine obtained from a shallow aquifer.

39. The method of claim 36, wherein the sorbent material is wetted by immersion in water.

40. The method of claim 36, wherein the sorbent material is wetted by exposure to humid air.

41. The method of claim 36, wherein the sorbent material is wetted by exposure to short pulses of steam.

42. The method of claim 36, wherein the sorbent material is an ion exchange resin.

43. The method of claim 20, wherein the component condensed out of said gas mixture is water.

44. The method of claim 20, wherein the component condensed out of said gas mixture is CO₂.

45. The method of claim 44, wherein CO₂ condensed out of said gas mixture forms dry ice.

46. The method of claim 36, wherein condensed water is collected, which is optionally reused in a subsequent wetting step.

47. A method for the collection of CO₂ from air, comprising the steps of exposing a module comprising a sorbent material to ambient air, thereby capturing CO₂ on said sorbent material; and releasing captured CO₂ from said sorbent material, characterized by one or more of the following features:
(a) wherein said module collects one ton of CO₂ per day;
(b) wherein said module collects 0.25 mol of CO₂ per second;
(c) wherein said sorbent material has a packing density of about 100 kg per cubic meter;
(d) wherein a kilogram of said sorbent material is capable of exhaling several hundred liters of CO₂ at a backpressure of 0.1 bar; and
(e) producing a gas mixture comprising water vapor and CO₂, each with a partial pressure between 1 kPa and 10 kPa;

48. A method for the collection of CO₂ from air, comprising the steps of exposing a sorbent material to ambient air; treating water to form a treated liquid water; and releasing captured CO2 by contacting said sorbent material with said treated water.

49. The method of claim 48, wherein treating said water comprises evaporating and condensing said water.

50. The method of claim 48, wherein treating said water comprises exposure to an anion exchange resin.

51. The method of claim 48, wherein treating said water comprises the use of an electrodialysis station.

52. The method of claim 48, wherein treating said water comprises adding carbonate to said water.

53. A method for capturing carbon dioxide from a gas stream, comprising passing the gas stream in contact with a sorbent to absorb carbon dioxide, regenerating the sorbent to form a gas mixture comprising carbon dioxide and water vapor, and compressing released CO₂ using a refrigeration medium.

54. The method of claim 53, wherein said refrigeration medium is liquid nitrogen or liquid air.

55. The method of claim 53, wherein said refrigeration medium is produced using an intermittent source of electricity.

56. The method of claim 55, wherein said intermittent source of electricity is solar energy or wind energy.

57. A method for removing and sequestering a contaminant contained in a gas stream comprising: bringing said gas stream in contact with a sorbent material, wherein the contaminant attaches to the sorbent material; wetting the sorbent material to release the contaminant to an off-stream; and passing the off-stream through an evaporative cooling chamber, wherein the off-stream is cooled by the evaporation of contaminated water external to said evaporative cooling chamber.

58. The method of claim 57, wherein said sorbent material is wetted with fresh water.

59. The method of claim 57, further comprising recovering water vapor from the off-stream.

60. The method of claim 57, wherein fresh water is produced as a byproduct.
